(19) United States
(12) Patent Application Publication
(10) Pub. No.: US 2015/0339393 A1
(43) Pub. Date: Nov. 26, 2015

(54) METHOD, SYSTEM AND COMPUTER-READABLE RECORDING MEDIUM FOR PROVIDING SURVEY BASED ON SEARCH RESULT

(71) Applicant: NAVER CORPORATION, Seongnam-si (KR)

(72) Inventors: Hyun Mee CHUNG, Seongnam-si (KR); Sang Chul LEE, Seongnam-si (KR); Sang Hyun LIM, Seongnam-si (KR); Hye Kyung PARK, Seongnam-si (KR)

(21) Appl. No.: 14/716,967

(22) Filed: May 20, 2015

(30) Foreign Application Priority Data
May 23, 2014 (KR) 10-2014-0062606

(51) Int. Cl. G06F 17/30; G06Q 10/06

(52) U.S. Cl. CPC G06F 17/30867; G06F 17/30554; G06Q 10/063

(57) ABSTRACT

Provided are a search-based survey system, apparatus, and/or method. The system may include a survey registration server, the survey registration server including a memory having computer readable instructions stored thereon, and one or more processors configured to execute the computer readable instructions to register at least one survey provided by a survey registration terminal, receive a search word from an answering terminal, match the search word with keywords of registered surveys, display, in a region of a search result screen, a survey corresponding to the matched search word, receive, from the answering terminal, an answer to the survey displayed, and provide a benefit when the answer satisfies a desired condition.

### CROSS-REFERENCE TO RELATED APPLICATION

This application claims the benefit of Korean Patent Application No. 10-2014-0062606, filed on May 23, 2014, in the Korean Intellectual Property Office, the disclosure of which is incorporated herein in its entirety by reference.

### BACKGROUND

1. Field

One or more example embodiments relate to a system and/or method for providing a search-based survey, and more particularly, to a system and/or method configured to display, on a search result screen, a survey with a keyword corresponding to a search word input by a user and providing a predetermined reward to a user who answers the survey.

2. Description of the Related Art

Online surveys are conducted to obtain statistical data online and are less limited than an offline survey in terms of time spent conducting the survey and the costs associated with conducting the survey before meaningful results are collected. Thus, online surveys have been widely used. However, since the targets of online surveys are generally randomly determined, the statistical reliability of the results of online surveys is lower than that of offline surveys.

### SUMMARY

One or more example embodiments include displaying, on a search result screen, a survey and/or poll related to and/or corresponding with a keyword related to a search query input by a user.

One or more example embodiments include providing a desired and/or predetermined reward to users who answer a survey, questionnaire, and/or poll (or the like), and determining the costs of the survey, questionnaire, and/or poll (or the like) in consideration of the sum of the provided rewards and the sample size of answers.

Additional aspects will be set forth in part in the description which follows and, in part, will be apparent from the description, or may be learned by practice of one or more example embodiments.

According to one or more example embodiments, a search-based survey system may include a survey registration server, the survey registration server possibly including a memory having computer readable instructions stored thereon and one or more processors. The one or more processors may be configured to execute the computer readable instructions to register at least one survey provided by a survey registration terminal, receive a search word from an answering terminal, match the search word with keywords of registered surveys, display, in a region of a search result screen, a survey corresponding to the matched search word, receive, from the answering terminal, an answer to the survey displayed, and provide a benefit when the answer satisfies a desired condition.

The one or more processors may be configured to execute the computer readable instructions to display the survey corresponding to the matched search word next to a search result display region of the search result screen.

The one or more processors may be configured to execute the computer readable instructions to display a plurality of surveys corresponding to the matched search word in one survey display region, and may display the plurality of surveys according to a degree of urgency for each of the plurality of surveys.

The one or more processors may be configured to execute the computer readable instructions to display the benefit provided together with the survey corresponding to the matched search word.

The desired condition may be based on a ratio of a total number of answered survey questions to a total number of survey questions included in the survey is equal to or greater than a desired ratio.

The one or more processors may be configured to execute the computer readable instructions to select an answering terminal from a plurality of answering terminals on which the survey is to be displayed, based on at least one feature of the survey.

The one or more processors may be configured to execute the computer readable instructions to randomly select an answering terminal from the plurality of answering terminals, select an answering terminal from a group of answering terminals from the plurality of answering terminals, or may select an answering terminal from the plurality of answering terminals that accesses the survey system by using a desired range of Internet protocol (IP) addresses or a desired device.

The one or more processors may be configured to execute the computer readable instructions to: receive a request to post the survey from the survey registration terminal, and register the survey, wherein the request includes at least one survey question, determine a keyword corresponding to the survey, based on the at least one survey question included in the request, and determine survey costs, based on a target sample size and a reward included in the request.

The one or more processors may be configured to execute the computer readable instructions to receive a request to post the survey from the survey registration terminal and register the survey, wherein the request may include at least one survey question, determine a keyword corresponding to the survey, based on the at least one survey question included in the request, determine survey costs, based on a target sample size and a reward included in the request, and provide surveys to the answering terminal in order to display the surveys on a region of a search result screen.

The one or more processors may be configured to execute the computer readable instructions to determine a keyword group corresponding to the at least one survey question, and may be configured to select at least one keyword belonging to the keyword group as keywords corresponding to the survey.

The one or more processors may be configured to execute the computer readable instructions to determine survey costs based on adding a total value of all rewards, which are to be provided to the answering terminal, and costs of exposure to the survey.

The request to post the survey may include at least one of: the at least one survey question, at least one example of answers corresponding to the at least one survey question, a reward, a target sample size, a duration of positing the survey, a keyword, a related field, a target survey group, a target exposure frequency, and a target survey finish date.

The one or more processors may be configured to execute the computer readable instructions to determine whether keywords associated with a keyword group corresponding to the at least one survey question are relevant to the at least one survey question, and based on the determination, display the survey when a user of the answering terminal searches for the determined keywords.

According to one or more example embodiments, a search-based survey method may include registering a survey by using a survey registration terminal; receiving a search word from an answering terminal, matching the search word with keywords of registered surveys, displaying, in a region of a search result screen, a survey corresponding to the matched search word, receiving, from the answering terminal, an answer to the survey, and providing a benefit when the answer satisfies a desired condition.

The displaying of the survey may include displaying the survey corresponding to the matched search word next to a search result display region of the search result screen.

The displaying of the survey may include displaying a plurality of surveys corresponding to the matched search word in one survey display region, and displaying the plurality of surveys according to a degree of urgency for each of the plurality of surveys.

The displaying of the survey may include displaying the benefit to be provided during the providing of the reward, together with the survey corresponding to the matched search word.

When a plurality of survey questions are included in the survey, the desired condition may be based on a ratio of a total number of answered survey questions to a total number of survey questions included in the survey is equal to or greater than a desired ratio.

The displaying of the survey may include selecting an answering terminal on which the survey is to be displayed, based on at least one feature of the survey.

The displaying of the survey may include randomly selecting an answering terminal, selecting an answering terminal from a group of answering terminals, or may select an answering terminal that accesses the survey system, by using a desired range of Internet protocol (IP) addresses or a desired device.

The registering of the survey may include collecting the survey by receiving a request to post the survey from the survey registration terminal and registering the survey, wherein the request includes at least one survey question, determining a keyword corresponding to the survey, based on the at least one survey question included in the request, and determining survey costs, based on a target sample size and a reward included in the request.

According to one or more example embodiments, a search-based survey method may include collecting the survey by receiving a request to post the survey from the survey registration terminal, wherein the request includes at least one survey question, determining a keyword corresponding to the survey, based on the at least one survey question included in the request, determining survey costs, based on a target sample size and a reward included in the request; and providing the survey to the answering terminal to display the survey on a region of a search result screen.

The determining of the keyword may include, after determining a keyword group corresponding to the at least one survey question, selecting all keywords belonging to the keyword group as keywords corresponding to the survey.

The determining of the survey costs may include determining survey costs by adding a total value of all rewards, which are to be provided to the answer terminal, and costs of exposure to the survey.

The request to post the survey may include at least one of: the at least one survey question, examples of answers corresponding to the at least one survey question, a reward, a target sample size, a duration of positing the survey, a keyword, a related field, a target survey group, a target exposure frequency, and a target survey finish date.

According to one or more example embodiments, a non-transitory computer readable recording medium having embodied thereon a computer program, which when executed by a computer, performs the method.

### BRIEF DESCRIPTION OF THE DRAWINGS

The foregoing and other features of some example embodiments will be apparent from the more particular description of non-limiting embodiments, as illustrated in the accompanying drawings in which like reference characters refer to like parts throughout the different views. The drawings are not necessarily to scale, emphasis instead being placed upon illustrating principles of at least one example embodiment. In the drawings:

FIG. 1 is a diagram schematically illustrating a search-based survey system according to an example embodiment;

FIG. 2 is a block diagram of a survey providing server of the search-based survey system of FIG. 1, according to an example embodiment;

FIG. 3 illustrates an example of a survey displayed on a search result screen according to an example embodiment;

FIG. 4 illustrates a survey setting screen provided to a survey registration terminal according to an example embodiment;

FIG. 5 is a table showing a conversion rate according to a reward and the number of questions, according to an example embodiment;

FIG. 6 is a table particularly illustrating a method of determining costs of a survey according to an example embodiment;

FIGS. 7 and 8 illustrate examples of surveys displayed on a search result screen according to other example embodiments;

FIG. 9 illustrates a screen to be displayed when answering a survey is completed according to an example embodiment; and

FIG. 10 is a flowchart of a search-based survey method according to an example embodiment.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

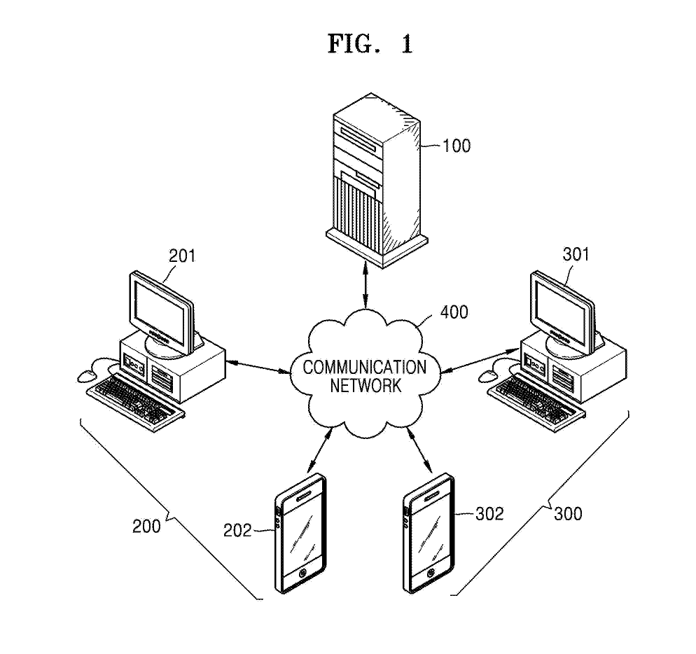

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein FIG. 1 is a diagram schematically illustrating a search-based survey system according to an example embodiment.

Referring to FIG. 1, a search-based survey system according to an example embodiment may include survey registration terminals 200, answering terminals 300, and a survey providing server 100. The survey providing server 100 may receive a request to post a survey from the survey registration terminals 200, may post a survey corresponding to a search result, may receive a search word from the answering terminals 300, and may display a survey with a keyword matching the search word on a region of a search result screen. The survey providing server 100 may be connected to and/or may be related to or associated with a search engine website, social media website, news website, shopping website, educational website, content providing website, web portal, an Internet Service Provider, mobile device application (e.g., smartphone app, tablet app, etc.), software program, or the like. The survey providing server 100 may transmit and receive information relevant to the survey participants to these other websites, services, service providers, and/or servers, such as web browsing information, demographic information, purchasing history, or the like, in order to determine the user profile of the survey participant.

The search-based survey system according to an example embodiment may provide a user with a survey corresponding to a search result, and provide a benefit to the user so that the user may actively answer the survey, thereby increasing the probability that a user will start and/or complete the survey and providing a search result to a person who has registered the survey.

Referring back to FIG. 1, the answering terminals 300 and the survey registration terminals 200 should be understood as communication terminals through which a web service may be used in a wire/wired communication environment, such as a computer network, an intranet, a Personal Area Network, a Local Area Network, a Wide Area Network, and/or the Internet. Here, the answering terminals 300 may be a computing device, such as a personal computer 201 (e.g., a PC, laptop, or the like) or a mobile terminal 202 (e.g., a mobile phone, a tablet, a PDA, or the like) of a user. Similarly, the survey registration terminals 200 may be a computing device, such as a personal computer 301 (e.g., a PC, laptop, or the like) or a mobile terminal 302 (e.g., a mobile phone, a tablet, a PDA, or the like) of an answering user, i.e., a survey participant or survey taker. In at least one example embodiment, operations of the survey registration terminals 200 and the answering terminals 300 may be described as reflecting the behaviors of a survey registrant and a survey participant. For example, example embodiments describing the receiving information from a survey registrant may be understood as receiving the information from the survey registration terminal 200.

A communication network 400 may connect the answering terminals 300 and the survey registration terminals 200 to the survey providing server 100. That is, the communication network 400 may be a communication network that provides an access path through which the answering terminals 300 and the survey registration terminals 200 may access the survey providing server 100 to exchange data, such as packet data, with one another.

The survey providing server 100 may receive a search word from the answering terminal 300, may match the search word with the keywords of registered surveys, may provide a survey (and/or poll, questionnaire, medical history form, personal history form, employment history form, information request form, data collection form, census, or the like) corresponding to the matched search word, may receive an answer, responses, results, information, and/or data to the survey from the answering terminal 300, and may provide a desired (and/or predetermined) benefit to the answering terminal 300. While use of the word “survey” is used in connection with the discussion of the example embodiments for the sake of convenience, other types of information gathering requests, such as polls, questionnaires, censuses, or the like, are also considered within the scope of the example embodiments. In this case, the survey may be provided from the survey providing server 100 in response to a request to post the survey, and the request may be received from the survey registration terminal 200. The costs of the survey may be estimated according to various criteria associated with the posted survey, such as the estimated time to complete the survey, the length of the survey, how many answers, responses, results, information, and/or data are desired and/or required to be received, how many survey participants are desired and/or required, etc., and then the survey registration terminal 200 may be asked to pay the costs.

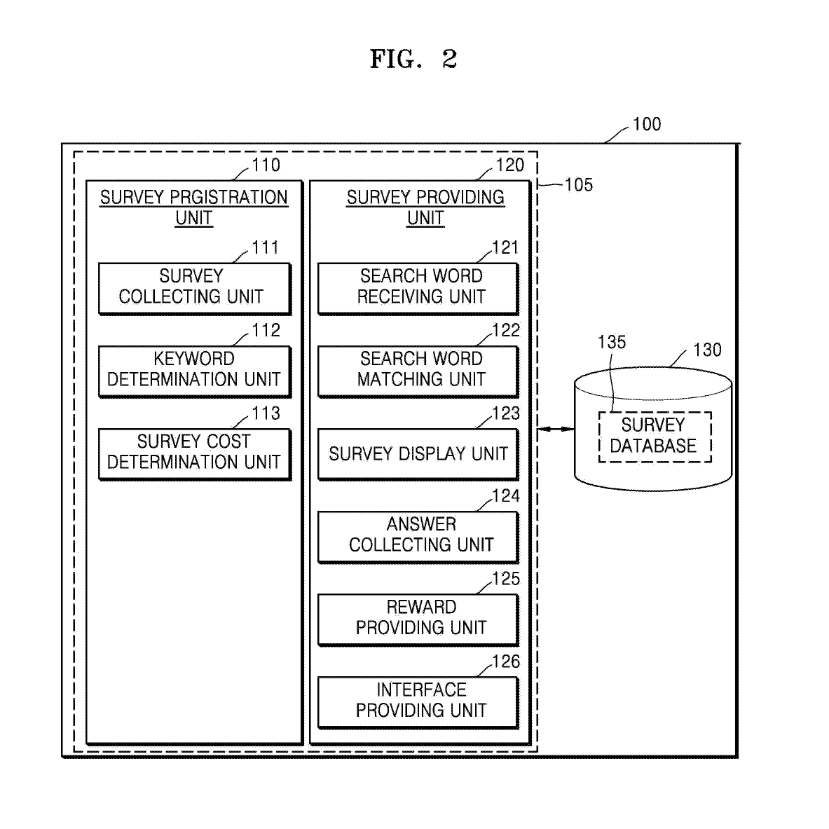

FIG. 2 is a block diagram of the survey providing server 100 of the search-based survey system of FIG. 1, according to an example embodiment.

Referring to FIG. 2, the survey providing server 100 according to an example embodiment may include at least one processor 105 and memory 130. The at least one processor 105 (hereinafter referred to in the singular form) may be configured to process computer readable instructions of, for example, a computer program by performing a basic arithmetic and logic operation, and an input/output (I/O) operation of the survey providing system, thereby transforming the processor 105 into a special purpose processor. The computer readable instructions may be stored on the memory 130 or other memory. The processor 105 may be configured to execute the computer readable instructions to configure as one or more program modules such as the survey registration unit 110 and/or survey providing unit 120. The program modules may be stored at least in part in a storage device such as the memory 130.

The memory 130, as non-transitory computer readable media, may include at least one permanent mass storage device such as random access memory (RAM), read only memory (ROM), a hard drive, a disk drive, and/or the like. Also, a program module for an Operating System may be stored in the memory 130. The software constituent elements may be loaded from non-transitory computer-readable media separate from the memory 130 using a drive mechanism (not shown). The non-transitory computer-readable media may include computer-readable media such as a floppy disk, a tape, a DVD/CD-ROM drive, and/or a memory card. According to other example embodiments, the software constituent elements may be loaded to the memory 130 through the communication network 400, instead of using the non-transitory computer readable media.

The memory 130 may be configured to store program modules for survey registration unit 110 and a survey providing unit 120, to be executed by the processor 105. The memory 130 may also store a database 135. The program module for the survey registration unit 110 may also include program modules for a survey collecting unit 111, a keyword determination unit 112, and a survey cost determination unit 113. The survey providing unit 120 may include program modules for a search word receiving unit 121, a search word matching unit 122, a survey display unit 123, an answer collecting unit 124, and a reward providing unit 125.

The survey registration unit 110 according to an example embodiment may receive a request to post a survey from the survey registration terminal 200, may determine a keyword of the survey to be registered, and may estimate the costs of providing the survey to the answering terminal 300.

The survey collecting unit 111 may receive a request to post a survey including at least one survey question from the survey registration terminal 200, and may register the survey. The survey collecting unit 111 may extract, from a collected request to post a survey, at least one among survey questions, examples of answers corresponding to the survey questions, a reward, a target sample size, a duration of posting the survey, a keyword, a related field, a desired survey group, a target exposure frequency, a target survey finish date, and the like.

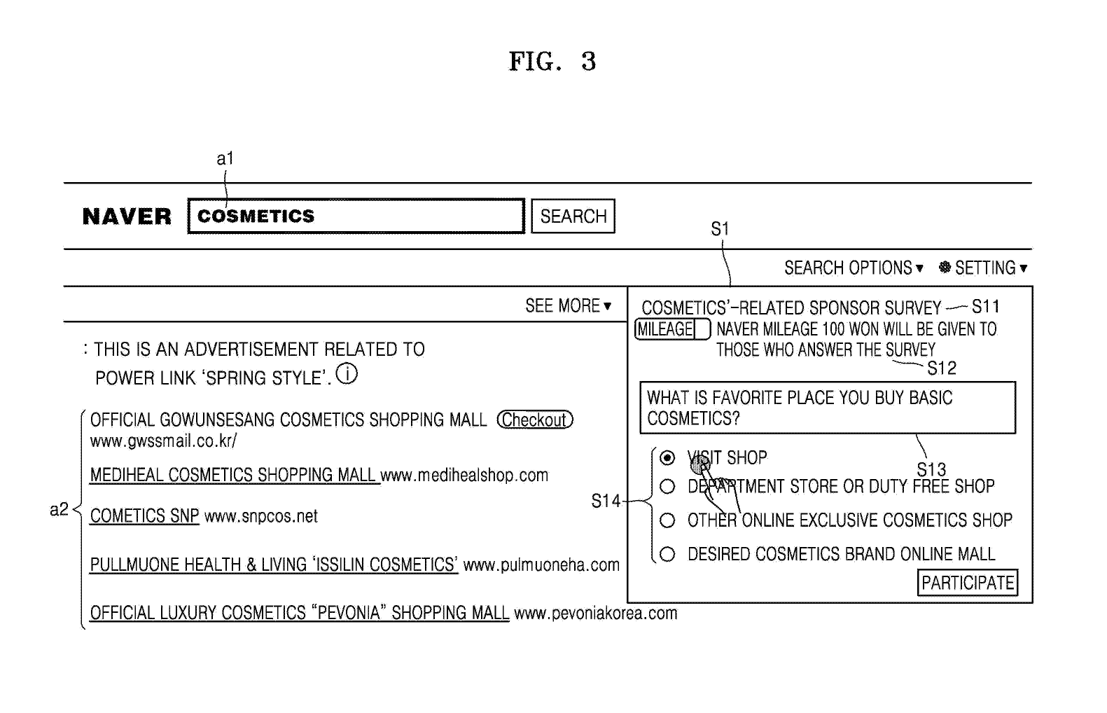

FIG. 3 illustrates a survey displayed on a search result screen according to an example embodiment.

Referring to FIGS. 2 and 3, a survey registered by the survey collecting unit 111 may be displayed on a first survey display region 51 of a search result screen. The first survey display region 51 may be an area of a website typically reserved as an advertisement region or a blank region, and/or may be displayed at a side of the search result screen. In this case, a survey displayed on the first survey display region 51 may include survey information related to a keyword that a user inputs into a search window al for a search engine website, web portal, social media website, news website, Internet content providing service, educational website, mobile device application (e.g., smartphone app, tablet app, etc.), software program, or the like.

Referring to FIG. 3, when a search keyword input by a user is ‘cosmetics’, for example, the survey providing server 100 may provide survey information related to ‘a location at which you usually buy basic cosmetics’. A user may receive a desired (and/or predetermined) benefit, e.g., monetary compensation, points for a rewards program, such as airline rewards mileage points, gift cards, or the like, when he or she answers and/or completes the survey. Because users who are interested in the field of the survey are the targets of the survey, the person, business, and/or entity who registered the survey may obtain useful, meaningful, and/or relevant survey results. In another example, a survey registrant may be interested in conducting political polling in connection with a certain political candidate, political party and/or political issue. The registrant may register a poll and/or survey for a search keyword related to the political candidate, political party and/or political issue. The registrant may then supply the poll and/or survey questions to the survey providing server 100, and a user who searches for the registered keyword may be presented with the poll and/or survey questions by the survey providing server 100.

A search word and a keyword according to an example embodiment will be described in detail below.

In an example embodiment, the survey collecting unit 111 may receive a request to post the survey displayed on the first survey display region S1 of FIG. 3. The survey collecting unit 111 may receive a request to post a survey including a survey question S13, reward information S12, examples of answers S14, etc. illustrated in FIG. 3.

In an example embodiment, a set of questions corresponding to a request to post a survey, questionnaire, poll, census, information request, or the like is referred to as a survey. A survey may include one survey question as illustrated in FIG. 3 or a set of survey questions. A survey question may be an objective or subjective question.

The keyword determination unit 112 according to an example embodiment determines a keyword based on a survey collected by the survey collecting unit 111. In an example embodiment, one survey may contain and/or be associated with a plurality of keywords. When a search word corresponding to one of the plurality of keywords is input, a survey with the keyword may be provided. For example, in the case of the survey displayed in the first survey providing region S1 of FIG. 3, the keyword may be cosmetics, female cosmetics, skin, lotion, foundation, etc.

As described above, a plurality of keywords may correspond to one survey. However, in most cases, a survey registrant may have difficulty selecting relevant and/or appropriate keywords that may correspond and/or relate to the survey the registrant desires to be registered. Thus, the keyword determination unit 112 may automatically compute (and/or otherwise identify) and register all keywords belonging to a specific keyword group that may be relevant to the survey as keywords of the survey. The keyword determination may be computed based on the study and analysis of empirical data collected regarding search queries, social media trends, and/or Internet browsing trends, or the like, associated with the provided survey, information provided by the survey registrant regarding the subject of the survey, and/or analysis of the survey questions and/or suggested survey answers. This information may be collected by monitoring the Internet and/or web browsing activities of a user, by for example, tracking the websites that the user visits using web browser cookies installed on the user's personal computer (e.g., 201, 301) and/or mobile device (e.g., 202, 302), tracking at the server level the search queries the user submits to a search engine, social media website, content providing website, and/or shopping website, etc., and/or by monitoring the user's Internet activities at the ISP level. For example, in the case of the survey displayed in the first survey providing region S1 of FIG. 3, a keyword group corresponding to a survey related to ‘cosmetics’ and thus the keyword determination unit 112 may register, as keywords of the survey, all keywords related to ‘skin’, ‘lotion’, ‘foundation’, etc., as well as topical keywords related to ‘cosmetics’, such as currently popular cosmetic products, companies, or the like. These keywords may belong to a keyword group related to ‘cosmetics’. The keyword determination unit 112 may add a new keyword to or delete a keyword from the keywords belonging to the keyword group when the survey registrant registers the survey.

Also, the keyword determination unit 112 may select a keyword of a survey to reflect the features of keywords. For example, when a search word is ‘hybrid camera’, a survey inquiring about ‘What is a camera manufacturing company that you can trust?’ may be appropriate, but a survey inquiring about ‘What is a camera type that you want most?’ may not be appropriate. This is because users who input the word ‘hybrid camera’ as a search word are likely to be users who want to purchase a hybrid camera or collect information regarding hybrid cameras rather than users who are also interested in other types of cameras. That is, the keyword ‘hybrid camera’ may only be appropriate for brand monitoring, but may not be appropriate for a market survey related to camera types. Thus, the keyword determination unit 112 may determine whether keywords within a keyword group may correspond to and/or be appropriate for a desired survey, and whether there exists keywords within the keyword group that do not correspond to and/or be appropriate for the desired survey. As another example, the keyword determination unit 112 may determine that a certain keyword within a keyword group is too broad and would cause an undesirable amount of uninterested and/or irrelevant users to be presented with the survey, and thus may determine that the keyword is not appropriate for the keyword group for the survey. An example of this would be a survey related to U.S. political figures, wherein one of the questions of the survey might relate to the U.S. politician Newt Gingrich. While the keyword “newt” may initially be one of the keywords in the keyword group associated with the survey, the keyword determination unit 112 may determine that the keyword “newt” may cause an undesirable amount of search engine users searching for information regarding the newt animal to be presented with the survey, and therefore remove the keyword from the keyword group associated with the survey. This determination may be determined, computed and/or processed using real-time analysis of empirical data regarding the web browsing activity data and/or user profile data collected and/or received by the survey providing server 100.

Also, the keyword determination unit 112 may select a keyword that reflects a matter of interest similar to that of a survey that respondents registered, and determine that the selected keyword may be a keyword of the survey. According to an example embodiment, a survey registrant may determine whether users are interested in a survey that the survey registrant registered without additionally detecting a group of users who are not interested in the survey, based on a search word input by the users. Thus, according to an example embodiment, when a search word that a user inputs matches a matter of interest of a survey, the survey may be displayed as a search result. The keyword determination unit 112 may select, as a keyword of the survey, a keyword or a keyword group reflecting a matter of interest similar to that of a survey that a respondent registered. For example, when a survey inquires about ‘What is the color of a skirt that you think will be popular this spring?’, a keyword directly related to the survey may be ‘skirt’, ‘spring skirt’, ‘popular color’, etc. but a keyword reflecting a matter of interest similar to that of the survey may be extended to ‘popular fashion’, ‘spring fashion’, ‘women's fashion’, etc. and one of them may be determined as a keyword of the survey.

The survey cost determination unit 113 according to an example embodiment may determine survey costs of conducting a survey (which is requested to be posted) registered by the survey registration terminal 200 and inform the survey registration terminal 200 of the survey costs. The survey cost determination unit 113 may determine costs based on various criterion and/or factors, such as the number of participants are desired and/or required to participate in the survey, the number of questions to be presented in the survey, the estimated length of time the survey is expected to take to complete, the number of complete responses desired and/or required, the demographic profile of desired survey participants, the estimated cost of rewards necessary to attract and/or compensate survey participants to participate in the survey, etc. The survey cost determination unit 113 may estimate these criterion and/or factors using empirical results from previous surveys presented, Internet, phone and computer usage trends, search engine query trends, and the like.

For example, the survey cost determination unit 113 may receive information regarding a target sample size and a reward from the survey registration terminal 200, and may determine the survey costs based on these factors. The target sample size may refer to the number of valid answers showing meaningful statistics, the number of participants who start a survey, the number of Internet users who were presented with the opportunity to participate in the survey, etc. The reward may be provided from the reward providing unit 125 which will be described in detail below with respect to the answering terminal 300 when a valid answer for one survey is received from the answering terminal 300. The survey registrant may set the target sample size and the reward in a survey setting screen created when registration of a survey is requested.

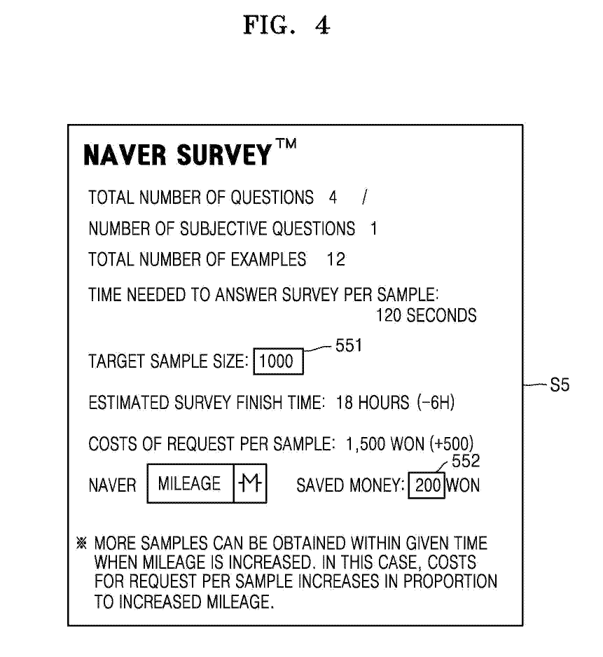

FIG. 4 illustrates a survey setting screen S5 provided to a survey registration terminal according to an example embodiment.

In the reward setting screen S5, the total number of questions, the number of subjective questions, the total number of examples, a sample time per survey, an estimated survey finish time, and costs of a request for each sample may be displayed. A survey registrant may input a target sample size and a reward in the reward setting screen S5.

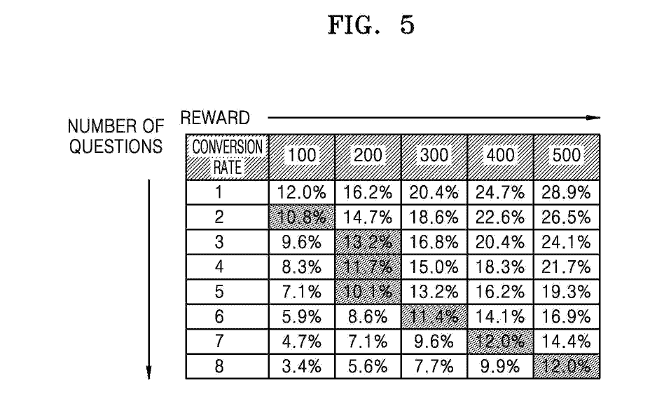

In the embodiment of FIG. 5, the total number of questions, the number of subjective questions, and the total number of examples may be displayed by analyzing a request to post a survey which is registered by the survey registration. A time needed to answer a survey for each sample may also be displayed in the form of an experience point, based on the total number of questions, the number of subjective questions, and the number of examples. The survey registrant may input a target number of valid answers for the registered survey into a target sample size input window S51, and input a reward to be provided to a survey participant who provides a valid answer into a reward input window S52.

The estimated survey finish time may be determined based on the target sample size and the reward. As the target sample size is high and the reward is low, the estimated survey finish time may increase.

When the survey registrant inputs values into the target sample size input window S51 and the reward input window S52 of the survey setting screen S5, the survey cost determination unit 113 may determine costs of a request for each sample. In this case, the survey cost determination unit 113 may determine survey costs by adding costs of exposing a survey and the reward to be provided to survey participants.

In an example embodiment, the survey cost determination unit 113 may determine the survey costs to be high as the target sample size is high and the reward is high. Also, the survey cost determination unit 113 may determine the survey costs based on a conversion rate according to the reward and the number of survey questions. The conversion rate means a ratio of the number of valid answers to the number of times that the survey is exposed. For example, if a number of times that a survey is exposed is ‘100’ and the number of valid answers obtained by normally answering the survey is ‘20’, the conversion rate is 20%.

FIG. 5 is a table showing a conversion rate according to a reward and the number of questions.

The table of FIG. 5 shows empirical statistics that may vary according to various modifications of an example embodiment. Referring to FIG. 5, when a reward is ‘100’ and one survey question is included in one survey, the conversion rate is 12.0%. This means that an average number of valid answers is ‘12’ when a survey with one survey question is exposed 100 times. Thus, in order to obtain 100 valid answers, the survey should be exposed 833 times (=100/0.12). As shown in FIG. 4, if the same reward is given, the conversion rate decreases as the number of survey questions belonging to one survey increases. Also, if the same number of questions are given, the conversion rate increases as the reward increases.

In an example embodiment, survey costs are high and valid answers are not likely to be sincere when the conversion rate is extremely high, and it may take a long time to obtain a target sample size when the conversion rate is extremely low. Thus, a ratio of the reward to the number of questions may be determined such that the conversion rate is about 10%.

In an example embodiment, for the same survey, the conversion rate may vary according to sex, age, or other factors. For example, for a particular survey, the conversion rate of users in their teens may be higher than that of users in their twenties. Since it would be difficult or undesirable to provide different rewards according to sex or age, a reward may be provided such that an average conversion rate of one survey is equal to a target conversion rate. For example, if the number of survey questions is five, a reward is 200 won, and 100 target sample sizes are needed, when the conversion rate of survey targets in their teens is 15% and the conversion rate of survey targets in their twenties is 5%, fifty samples may be exposed to the survey targets in their teens and ten samples may be exposed to the survey targets in their twenties.

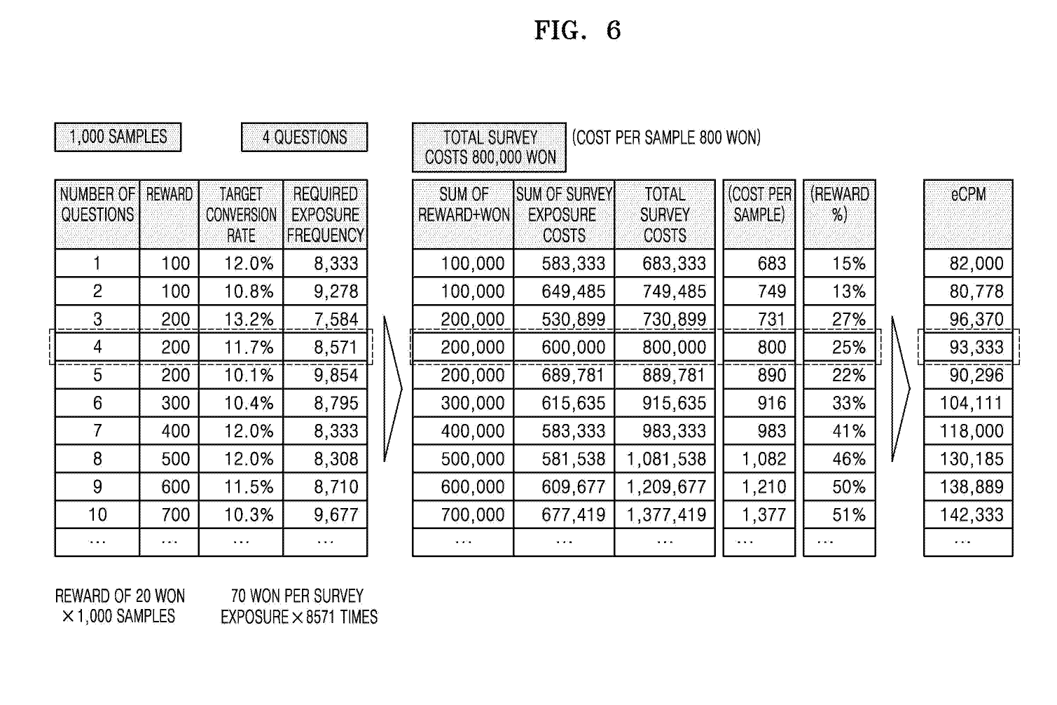

FIG. 6 is a table particularly illustrating a method of determining costs of a survey according to an example embodiment.

FIG. 6 illustrates a method of estimating costs of a request for each sample and total survey costs when a survey registration sets 1000 target samples and a reward of 200 with respect to a survey with four survey questions, in conjunction with FIG. 4. As described above with reference to FIG. 5, when the number of survey questions is four and the reward is 200, the conversion rate according to a reward and the number of survey questions is about 11.7% (and exactly, 11.66725%). Thus, in order to derive 1000 target sample sizes which is the number of valid answers, the survey should be exposed 8571 times (=1000/0.1166725).

As described above, survey costs may be calculated by adding costs of exposing a survey and the sum of paid rewards. In the embodiment of FIG. 6, when it is assumed that costs of exposing one survey is 70 won, the number of times that the survey is exposed is ‘8571’ and the costs of exposing the survey is 599970 won (=8571×70), and approximately, 600000 won. Also, the sum of paid rewards may be 200000 (=200×1000). Thus, the survey cost determination unit 113 may determine the total survey costs to be 800000 won. Since the target sample size is ‘1000’, a cost per sample may be 800 won. The calculated cost per sample is displayed in the ‘costs of each sample’ section of FIG. 4.

In terms of a survey system according to an example embodiment, a ratio of the sum of rewards to the survey costs of each survey is 0.25 (=200/800), i.e., 25%. Thus, the survey system according to an example embodiment may collect the remaining 75% of the survey costs as a profit. In terms of an advertisement policy, an effective cost per mile (eCPM) which is a cost per valid 1000 times exposure is 93333 won (=800000/8571×1000).

The survey cost determination unit 113 may display the determined survey costs on the reward setting screen S5 or ask the survey registration terminal 200 to pay therefor when a request to post a survey is received from the survey registration terminal 200.

The survey registration unit 110 may register information regarding the survey contained in the request to post the survey to the survey database 135, together with a keyword and the survey costs thereof. The survey database 135 may store not only information regarding the survey (e.g., examples of answers, a reward, a target sample size, a duration of posting the survey, a keyword, a related field, a desired survey group, a target exposure frequency, a target survey finish date, etc.) but also information regarding the survey registrant, information regarding desired, acceptable, and/or targeted survey participants of the survey, etc., in addition to survey questions.

The survey providing unit 120 may provide surveys registered by the survey registration unit 110 to the answering terminal 300. A method of providing a survey from the survey providing unit 120 will now be described, according to an example embodiment, focusing on operations of various elements of the survey providing unit 120.

First, the search word receiving unit 121 receives a search word from the answering terminal 200. Referring back to FIG. 3, when the answering terminal 200 inputs a search word into the search window al to do a search, the search word receiving unit 121 may collect the input search word.

The search word matching unit 122 matches the input search word with keywords of surveys registered by the survey registration unit 110. In detail, the search word matching unit 122 detects whether the input search word matches any one of a plurality of keywords registered related to surveys. For example, when the input search word is ‘cosmetics’, the input search word is matched with the plurality of keywords by detecting whether a survey with a keyword ‘cosmetics’ is registered to the survey database 135.

In an example embodiment, the survey display unit 123 may display a survey corresponding to the matched search word on a region of a search result screen. Referring back to FIG. 3, the survey question S13 displayed in the first survey display region S1 may be included in a survey with a keyword corresponding to the search word ‘cosmetics’. In this case, the first display region S1 may be displayed at a side of the search result screen. In the embodiment of FIG. 3, the first survey display region S1 is displayed to the right of a link advertisement display region a2 regarding a search word.

In another example embodiment, the survey display unit 123 may display a survey in a general search result display region of the search result screen other than an advertisement display region. In the embodiment of FIG. 3, since the first survey display region S1 is displayed to the right of the link advertisement display region a2, the displayed survey seems to look like an advertisement. Thus, the survey display unit 123 may display a survey at a side of a general search result display region, e.g., a blog search display region or a news search display region.

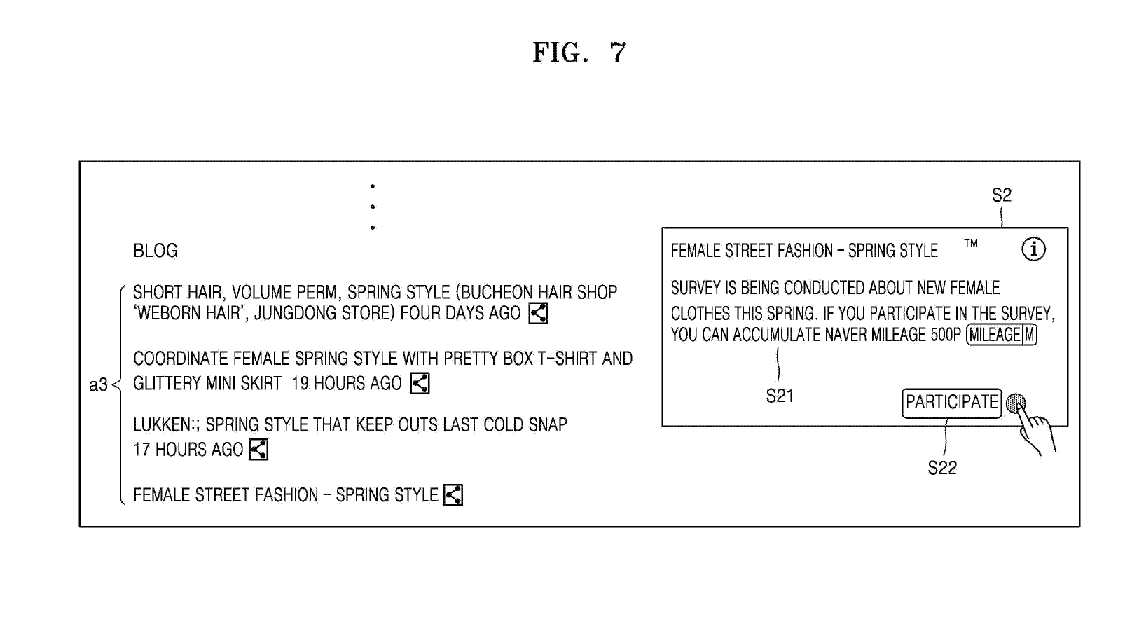

FIG. 7 illustrates an example of a survey displayed on a search result screen according to another example embodiment.

In the example embodiment of FIG. 7, a second survey display region S2 is displayed to the right of a blog search result a3. A survey is displayed near a search result in a search result screen other than an advertisement to limit and/or prevent the survey from being mistakenly recognized as an advertisement, unlike in the embodiment of FIG. 3, thereby increasing participation in the survey.

In the embodiment of FIG. 7, the survey displayed in the second survey display region S2 includes a plurality of survey questions. Unlike in the embodiment of FIG. 3, when one survey includes a plurality of survey questions, the survey questions may not be directly displayed in the second survey display region S2, and the second survey display region S2 may be switched to a survey providing screen when a survey participant expresses his/her intention to participate in the survey by selecting a ‘participate’ button S22. However, even if a plurality of survey questions are present, reward information S21 may be displayed in the second survey display region S2 to increase user participation in the survey.

When there are a plurality of surveys with a keyword matching a search word input by a user, the survey display unit 123 may display the plurality of surveys in a survey display region in the order of priority. In this case, priorities assigned to the surveys may be determined according to a degree of urgency. The degree of urgency may be a degree in which a survey is expected to not be finished by a target survey finish date when the target survey finish date and the progress of the survey are compared to each other.

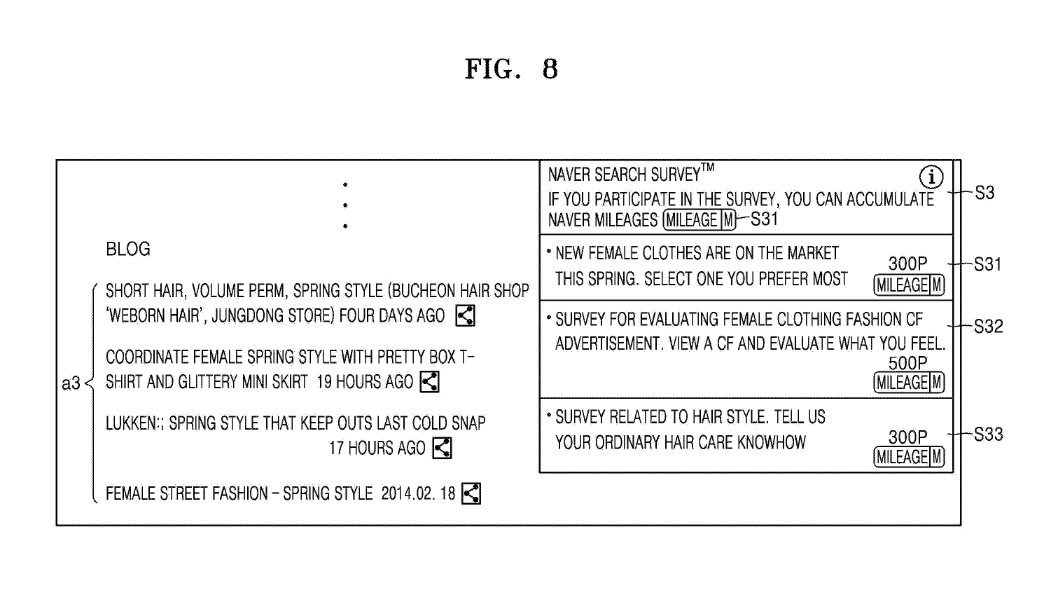

FIG. 8 illustrates an example of a survey displayed on a search result screen according to another example embodiment.

FIG. 8 illustrates a plurality of surveys displayed in a third survey display region S3 according to another example embodiment. In this case, a first survey S31, a second survey S32, and a third survey S33 may be sequentially displayed in the third survey display region S3. The first survey S31, the second survey S32, and the third survey S33 may be arranged in the order of priority. All the first survey S31, the second survey S32, and the third survey S33 have a search word as a common keyword. An answering may select at least one among the first survey S31, the second survey S32, and the third survey S33, and participate in the selected at least one survey.

In addition, the survey display unit 123 may select an answering terminal 300 on which a survey is to be displayed in a region of a search result screen, based on the features of the survey. The survey display unit 123 may select an answering terminal 300 on which a survey is to be displayed from among the answering terminals 300, based on identifiers of the answering terminals 300, e.g., an internet protocol (IP) address or a MAC address that each of the answering terminals 300 uses to access the survey providing server 100 according to an example embodiment via the communication network 400, the types or identifications (IDs) of the answering terminals 300, etc. Also, the survey display unit 123 may select an answering terminal 300 on which a survey is to be displayed from among the answering terminals 300, based on personal information of users who own and/or use the answering terminals 300.

More specifically, the survey display unit 123 may categorize the survey participants into several groups and select only an participants belonging to one of the groups, randomly select one of users who input the same search word, or select a participant who uses a specific IP or a specific device, and then display a survey only on the answering terminal 300 corresponding to the selected answering. Otherwise, a survey may be displayed on the answering terminals 300 except for the answering terminal 300 selected as described above.

For example, when a keyword of a survey is ‘idol’, the survey display unit 123 may categorize participants into a plurality of groups according to age, and display the survey only on answering terminals 300 corresponding to participants in their teens or twenties. Otherwise, the survey display unit 123 may not provide a survey related to a search word ‘idol’ to all users who input the search word ‘idol’, and may randomly select answering terminals 300 and display a survey only on the selected answering terminals 300. Otherwise, the survey display unit 123 may not display a survey on answering terminals 300 that are in the same IP range or access the survey providing server 100 using the same device even when the answering terminals 300 access the survey providing server 100 using different IDs, so that the answering terminals 300 may not repeatedly participate in the survey.

The answer collecting unit 124 may collect an answer from the answering terminal 300 regarding a survey. The answer collecting unit 124 may collect an answer number when a survey question of the survey is an objective question, and collect a text answer when the survey question is a subjective question. If one survey includes a plurality of questions, the answer collecting unit 124 may collect only some answers even when an answering does not answer all the plurality of questions.

When a collected answer satisfies a desired and/or predetermined condition, the reward providing unit 125 may provide a benefit to an answering terminal 300 that gives the answer. In this case, according to an example embodiment, a reward may be provided in the form of mileage that employed by a service company that provides a survey system according to an example embodiment. The reward providing unit 125 may provide the answer terminal 300 with a reward corresponding to a reward registered by the survey registration unit 110 described above.

The reward providing unit 125 may provide a reward to an answering terminal 300 only when an answer received from the answering terminal 300 satisfies a desired and/or predetermined condition, i.e., only when the received answer is a valid answer. For example, if one survey with only one survey question S13 is displayed in the survey display region S1 as illustrated in FIG. 3, only when one of the examples of answers S14 corresponding to the survey question S13 which is an objective question is selected and the ‘participate’ button is clicked, the selected answer is determined valid and a reward may be then provided. In the embodiment of FIG. 3, the reward providing unit 125 may display a reward and a reward providing condition as the reward information S12 when answering the survey displayed in the survey providing region S1 is completed.

According to another example embodiment, if one survey includes a plurality of survey questions, a reward may be provided when the ratio of the number of answers to the number of questions is equal to or greater than desired and/or predetermined percentages. Alternatively, the reward providing unit 125 may provide a reward only when a time needed to finish a survey for each sample which is a time period between a point of time that answering the survey starts and a point of time that the answering of the survey ends is less than or equal to a target time period.

In order to induce users to answer a survey, an interface providing unit 126 may provide information regarding the survey together with an advertisement or an appropriate interactive interface may be provided while the survey is conducted. For example, the interface providing unit 126 may provide vibration, visual indication, audible indication, or the like when a participant answers the survey, expand a selected example of an answer, display a moving character, or the like in order to try to induce the participant to answer the survey until the survey is finished. The interface providing unit 126 may be used to increase a rate of answering. In particular, the interface providing unit 126 may be applied to a survey with a large number of questions so as to increase the conversion rate.

In addition, when an advertiser registers a survey, the interface providing unit 126 may display a sentence inducing a user to participate in the survey and a reward to be provided when the user participates in the survey while displaying an advertisement corresponding to the survey, thereby encouraging, inducing, and/or causing the user to participate in the survey. Also, when a user finishes the survey, the interface providing unit 126 may display a screen indicating that the survey is finished and to indicate the reward provided from the reward providing unit 125, so that the user may receive information regarding whether the user successfully finishes the survey.

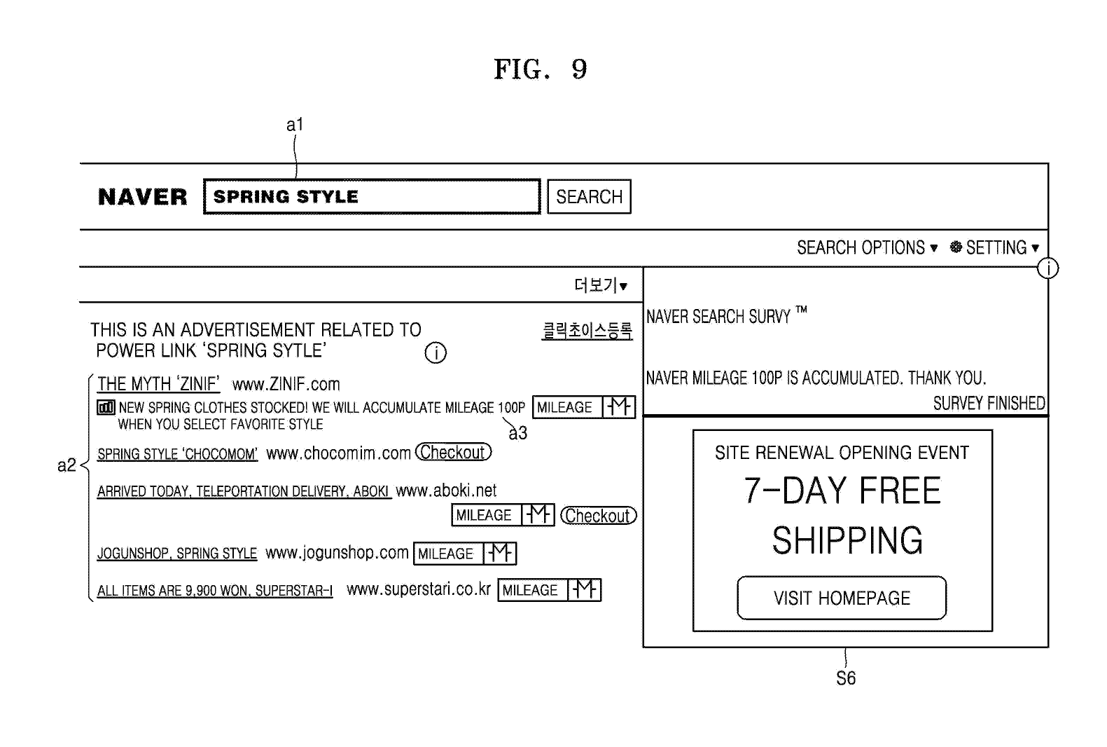

FIG. 9 illustrates a survey advertisement sentence or information indicating that a survey is answered according to an example embodiment.

As illustrated in FIG. 9, when a user inputs ‘spring style’ as a search word in a search window al, advertisements linked to sites related to spring style are displayed in a link advertisement display region a2. According to an example embodiment, when there is an advertiser who requests to register a survey among advertisers who register the linked advertisements, the interface providing unit 126 may display survey advertisement information a3 at the bottom of the linked advertisement corresponding to the advertiser. That is, when an advertiser of a linked advertisement and a survey registration are the same person, the survey advertisement information a3 inducing users to participate in a survey registered by the advertiser may be displayed at the bottom of the linked advertisement as illustrated in FIG. 9. The survey advertisement information a3 may contain information regarding a reward and a participant of the survey may select the survey advertisement information a3 to participate in the survey.

A screen to be displayed when a participant finishes answering a survey is illustrated at the right of FIG. 9. Referring to FIG. 9, an answering completion display region S6 is displayed instead of the survey display region S1 of FIG. 3. In the answering completion display region S6, a reward providing result and an advertisement may be displayed. The advertisement may be registered together with a survey by the survey registration terminal 200.

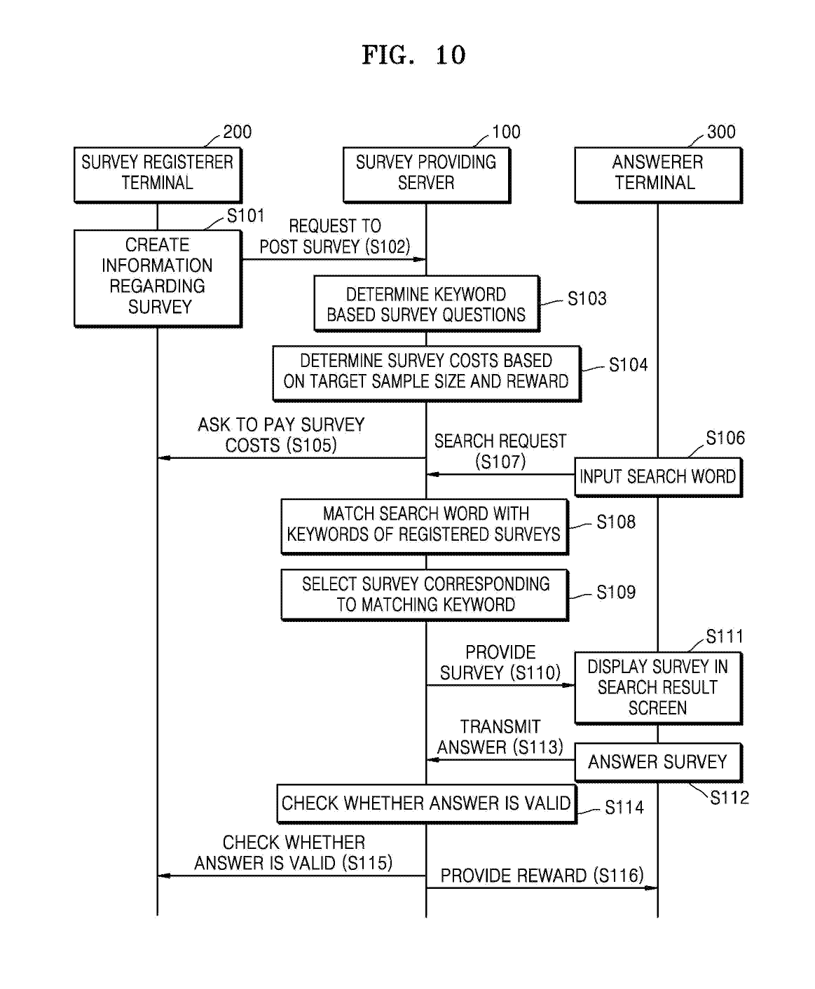

FIG. 10 is a flowchart of a search-based survey method according to an example embodiment.

First, after a survey registration terminal 200 creates information regarding a survey (operation S101), a survey providing server 100 receives a request to post the survey from the survey registration terminal 200 (operation S102). As described above, the request to post the survey may include information regarding the survey such as survey questions, examples of answers corresponding to the survey question, a reward, a target sample size, a duration of posting a survey, a keyword, a related field, a target survey group, a target exposure frequency, and a target survey finish date.

Next, the survey providing server 100 determines a keyword of the survey, based the survey questions included in the request (operation S103).

Next, the survey providing server 100 determines survey costs based on the target sample size and the reward included in the request (operation S104), and asks the survey registration terminal 200 to pay the survey costs (operation S105).

When a user inputs a search word into an answering terminal 300 to transmit a search request to the survey providing server 100 (operation S106), the survey providing server 100 matches the search word with keywords of registered surveys (operation S108).

Next, the survey providing server 100 selects a survey corresponding to the matched search word (operation S109).

The survey providing server 100 provides the selected survey to the answering terminal 300 (operation S10), and the answering terminal 300 displays the survey in a search result screen (operation S111).

Next, the participant answers the survey on the answering terminal 300 (operation S112) and transmits the answer to the survey providing server 100 (operation S113).

Next, the survey providing server 100 checks whether the answer is a valid answer (i.e., that the answer is relevant to the survey question and is not a garbage and/or automated answer or response) (operation S114). When the answer is a valid answer, the survey providing server 100 transmits a result of the survey to the survey registration terminal 200 (operation S115) and provides a reward to the answering terminal 300 (operation S116).

According to the one or more of the example embodiments, a survey related to a search word is provided to receive an answer to the survey from respondents who are interested in a subject related to the survey, thereby achieving a statistically meaningful search result.

Also, according to the one or more of the example embodiments, a desired and/or predetermined reward is provided to survey participants who answer a survey, thereby increasing a rate of participation in the survey. Also, a survey registrant may select a reward, so that a time needed to obtain a result of a survey may be flexibly selected according to the importance of the survey.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), three-dimensional memory arrays and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that the example embodiments described therein should be considered in a descriptive sense only and not for purposes of limitation. Descriptions of features or aspects within each example embodiment (method, system and/or apparatus) should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A search-based survey system comprising:
a survey registration server, the survey registration server including,
a memory having computer readable instructions stored thereon; and
one or more processors configured to execute the computer readable instructions to,
register at least one survey provided by a survey registration terminal,
receive a search word from an answering terminal,
match the search word with keywords of registered surveys,
display, in a region of a search result screen, a survey corresponding to the matched search word,
receive, from the answering terminal, an answer to the survey displayed, and
provide a benefit when the answer satisfies a desired condition.

2. The system of claim 1, wherein the execution of the computer readable instructions by the one or more processors causes the processor to display the survey corresponding to the matched search word next to a search result display region of the search result screen.

3. The system of claim 1, wherein, execution of the computer readable instructions by the one or more processors causes the processor to:
display a plurality of surveys corresponding to the matched search word in one survey display region; and
display the plurality of surveys according to a degree of urgency for each of the plurality of surveys.

4. The system of claim 1, wherein the execution of the computer readable instructions by the one or more processors causes the processor to display the benefit provided together with the survey corresponding to the matched search word.

5. The system of claim 1, wherein the desired condition is based on a ratio of a total number of answered survey questions to a total number of survey questions included in the survey is equal to or greater than a desired ratio.

6. The system of claim 1, wherein the execution of the computer readable instructions by the one or more processors causes the processor to select an answering terminal from a plurality of answering terminals on which the survey is to be displayed, based on at least one feature of the survey.

7. The system of claim 6, wherein the execution of the computer readable instructions by the one or more processors causes the processor to randomly select an answering terminal from the plurality of answering terminals, select an answering terminal from the plurality of answering terminals based on a group that the answering terminals are associated with, or select an answering terminal from the plurality of answering terminals that accesses the survey system by using a desired range of Internet protocol (IP) addresses or a desired device.

8. The system of claim 1, wherein the execution of the computer readable instructions by the one or more processors causes the processor to:
receive a request to post the survey from the survey registration terminal, and register the survey, wherein the request includes at least one survey question;
determine a keyword corresponding to the survey, based on the at least one survey question included in the request; and
determine survey costs based on a target sample size and a reward included in the request.

9. The system of claim 8, wherein, execution of the computer readable instructions by the one or more processors causes the processor to determine a keyword group corresponding to the at least one survey question, and select at least one keyword belonging to the keyword group as keywords corresponding to the survey.

10. The system of claim 8, wherein the execution of the computer readable instructions by the one or more processors causes the processor to determine survey costs based on a total value of all rewards which are to be provided to the answering terminal, and costs of exposure to the survey.

11. The system of claim 8, wherein the request to post the survey comprises at least one of:
the at least one survey question;
at least one example of answers corresponding to the at least one survey question;
a reward;
a target sample size;
a duration of positing the survey;
a keyword;
a related field;
a target survey group;
a target exposure frequency; and
a target survey finish date.

12. The system of claim 8, wherein the execution of the computer readable instructions by the one or more processors causes the processor to determine whether keywords associated with a keyword group corresponding to the at least one survey question are relevant to the at least one survey question, and based on the determination, display the survey when a user of the answering terminal searches for the determined keywords.

13. A search-based survey method comprising:
registering a survey by using a survey registration terminal;
receiving a search word from an answering terminal;
matching the search word with keywords of registered surveys;
displaying, in a region of a search result screen, a survey corresponding to the matched search word;
receiving, from the answering terminal, an answer to the survey; and
providing a benefit when the answer satisfies a desired condition.

14. The method of claim 13, wherein the displaying of the survey comprises displaying the survey corresponding to the matched search word next to a search result display region of the search result screen.

15. The method of claim 13, wherein, the displaying includes:
displaying a plurality of surveys corresponding to the matched search word in one survey display region; and
displaying the plurality of surveys according to a degree of urgency for each of the plurality of surveys.

16. The method of claim 13, wherein the displaying of the survey comprises displaying the benefit to be provided during the providing of the reward, together with the survey corresponding to the matched search word.

17. The method of claim 13, wherein, when a plurality of survey questions are included in the survey, the desired condition is based on a ratio of a total number of answered survey questions to a total number of survey questions included in the survey is equal to or greater than a desired ratio.

18. The method of claim 13, wherein the displaying of the survey comprises selecting an answering terminal from a plurality of answering terminals on which the survey is to be displayed, based on at least one feature of the survey.

19. The method of claim 13, wherein the displaying of the survey comprises randomly selecting an answering terminal, selecting an answering terminal from a group of answering terminals, or selecting an answering terminal that accesses the survey system, based on a desired range of Internet protocol (IP) addresses or a desired device.

20. The method of claim 13, wherein the registering of the survey comprises:
collecting the survey by receiving a request to post the survey from the survey registration terminal and registering the survey, wherein the request includes at least one survey question;
determining a keyword corresponding to the survey, based on the at least one survey question included in the request; and
determining survey costs, the survey costs determined based on a target sample size and a reward included in the request.
